(19) United States
(12) Patent Application Publication
(10) Pub. No.: US 2010/0242420 A1
(43) Pub. Date: Sep. 30, 2010

(54) Saddle Cinch

(75) Inventors: Robert Anthony Minniti, SR., Columbiana, OH (US); Julie Denise Minniti, Columbiana, OH (US)

Correspondence Address: Robert Minniti, 3405 West Garfield Road, Columbiana, OH, 44408, US

(73) Assignees: Robert, Columbiana, OH (US); Julie Denise Minniti, Columbiana, OH (US)

(21) Appl. No.: 12/725,187

(22) Filed: Mar. 16, 2010

Related U.S. Application Data
(60) Provisional application No. 61/160,358, filed on Mar. 16, 2009.

(51) Int. Cl. B68C 1/14

(52) U.S. Cl. 54/23

(57) ABSTRACT

A piece of saddlery equipment for facilitating the saddling of a horse by making it safer, quicker, and simpler the fastening of the cinch under the belly of the horse to the rigging of the saddle by the permanent attachment of the connecting straps to the opposing ends of the cinch. The cinch has a buckle on each end and a strap permanently attached to each end of the cinch. The strap permanently attached to the cinch loops through the rigging on the saddle once then runs through the buckle on the cinch and is secured to the cinch by placing the tongue of the buckle through the appropriate hole on the strap to ensure securement of the saddle to the horse.

### CROSS REFERENCE TO RELATED APPLICATION

This application is a standard utility which claims priority from U.S. Provisional Application Ser. No. 61/160,358 filed Mar. 16, 2009.

### FIELD OF THE INVENTION

The present invention relates to saddlery, and more particularly to permanently attaching the connecting straps (off-billet or latigo straps) to opposing ends of the cinch which permits a safe, quick, and simple securement of the cinch about the body of a horse to secure the saddle thereon.

### BACKGROUND OF THE INVENTION

A saddle is secured on a horse by using a cinch on Western saddles or a girth on English saddles. The cinch is connected to both sides of the saddle and passes under the body of the horse. One side of the cinch is permanently or removably connected to the off side (right side of the horse) of the saddle by an off-billet strap which is usually double looped around the D ring of the saddle then buckled. The other side of the cinch is constructed to be removably attached by a billet or latigo strap to the near side (left side of horse) of the saddle to enable the cinch to be placed about the body of the horse and then tightened. Most cinches have a buckle on each end. Through one end of the cinch on the near side, a connecting strap (billet or latigo) is looped one or more times through the buckle on the cinch and through the D-ring on the saddle then secured by either the tongue on the buckle or by looping the strap about itself forming a latigo knot. By making several loops with the strap, it requires the horseman to use considerable pulling strength in order to tighten the cinch about the horse due to the strap being looped upon itself and causing a sliding friction between the loops.

The disadvantages associated with the latigo knot are the cumbersomeness of tying and untying this knot, the lack of flexibility in the knot, the difficulty of adjusting this knot, the bulkiness of this knot under the rider's leg, the limiting movement of the horse, and the possibility of painful girth galls to the horse.

Another disadvantage with known cinches connected by billet or latigo straps is that the rider cannot quickly and safely untighten the saddle in an emergency if the horse suddenly becomes upset on the account of discomfort due to the tightness of the saddle and cinch.

Another disadvantage of known cinches connected by billet or latigo straps is that for beginning riders it can be a challenge for them to secure the saddle in such way as the saddle will not slip and that the cinch will be centered under the belly of the horse.

Another disadvantage of known cinches connected by billet or latigo straps is that the saddling and unsaddling of a horse can be an aggravation to both the horse and the rider due to the amount of time and energy put into the fastening and unfastening of the latigo knot. Securing the saddle by known cinches by billet or latigo straps can be very time consuming when having to saddle and unsaddle numerous horses throughout the day.

Another disadvantage of known cinches connected by billet or latigo straps is that they take a tremendous amount of stress and can get worn out relatively quickly therefore they need to be replaced more often than they are. If the cinch or connecting straps are not replaced when worn out, then it is possible that a serious accident could occur.

Therefore, the need exists for an improved cinch and in particular, a cinch which has the connecting straps permanently attached to opposing ends of the cinch to allow for a safe, quick, and simple securement of the saddle to the horse.

### SUMMARY OF THE INVENTION

The present invention provides a cinch and in particular, permanently attached connecting straps to opposing ends of the cinch for securing the saddle onto the body of the horse in a safe, quick, and simple manner. The present invention will allow the rider to inspect the cinch and connecting straps each time it is used. The present invention will allow the saddle to be secured to the horse by using less pulling strength when tightening the cinch around the horse. The present invention will result in a safe, quick, and simple way of securing the saddle to the horse without the bulkiness of current cinch connecting straps, the hazard of worn cinch connecting straps, or the burden of tying a latigo knot. The present invention allows faster saddling and unsaddling of a horse.

The cinch of this invention includes a cinch with a buckle on each end and with straps permanently attached to opposing ends of the cinch. The strap is looped under the D-ring on the saddle once then secured to the buckle of the cinch by inserting the tongue of the buckle through the appropriate hole for tightness on the strap. Each side of the saddle is secured by this improved cinch using the same method of attachment. The cinch of this invention replaces the need of having three separate pieces of saddlery equipment (cinch, off-billet, billet or latigo) with one improved piece of saddlery equipment.

The advantages, construction, and operation of the present invention will become more obvious from the following description and drawings.

### DRAWINGS

FIG. 1 is a perspective view of a saddle having a cinch with straps permanently attached to opposing ends of the cinch and secured to the saddle.

FIG. 2 is an enlarged fragmentary sectional view of the permanently attached strap to the cinch and shows the free end of the strap being secured in a fixed position on the cinch buckle.

FIG. 3 is a fragmentary plain view of the cinch having straps permanently attached to the opposing ends of the cinch.

FIG. 4 is a view similar to FIG. 2 showing the free end of the strap being secured in a fixed position on the cinch buckle and the excess of the free end of the strap being contained.

### CATALOG OF THE ELEMENTS

To aid in the correlation of the elements of the invention to the exemplary drawings, the following catalog of the elements is provided:
1 Saddle
2 Horn
4 D-ring
6 Saddle skirt
8 Rivets
10 Cinch
12 Connecting Straps
12 A permanently attached end of Strap
12 B Free end of Strap
14 Buckle
16 Holes on Strap
18 Locking Tongue on Buckle

### DESCRIPTION OF THE PREFERRED EMBODIMENT

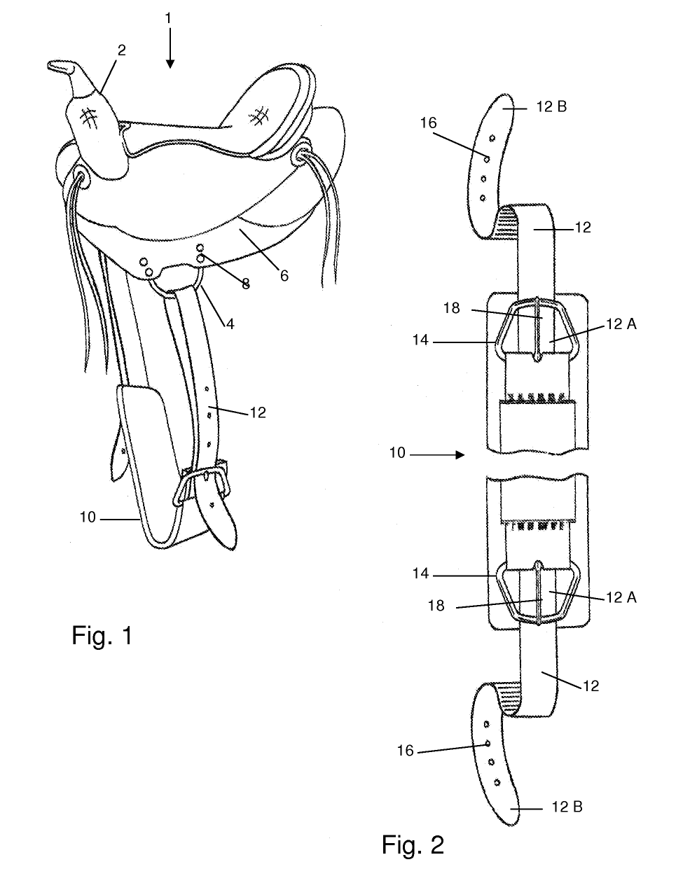

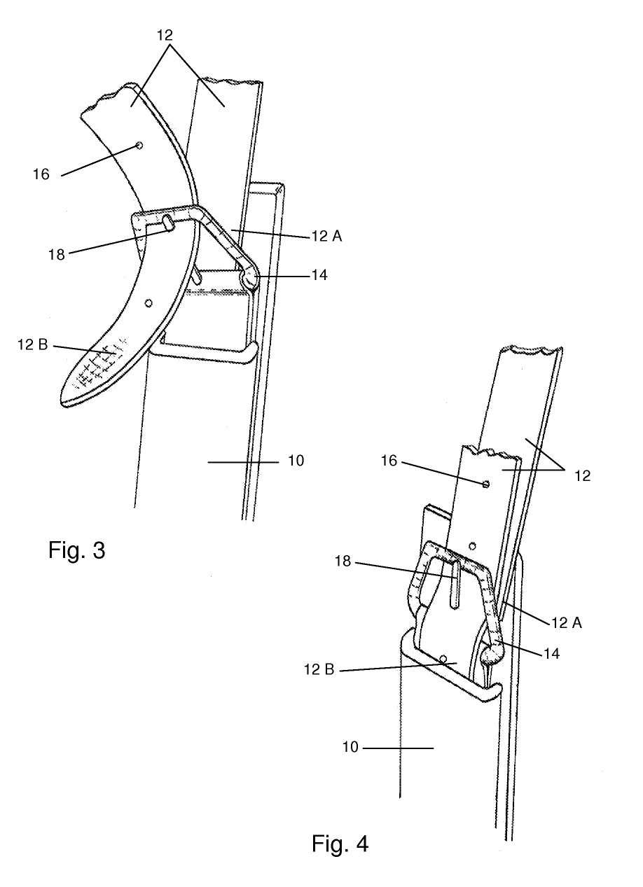

A Western style riding saddle 1 is shown in FIG. 1, indicated by having a horn 2. However, the present invention of the cinch with permanently attached straps to the opposing ends is applicable to other types of saddles than that shown in FIG. 1 and does not need to be limited by western saddles. Saddle 1 includes in-skirt D-ring 4 which is connected to the saddle skirt 6 by rivets 8 or by other types of connections. The Cinch 10, is shown in detail in FIG. 3, is made of felt, neoprene, or other soft material to protect the underbelly of the horse. The straps 12 which have one end permanently attached to each opposing end 12A of the cinch 10 and one free end 12B are made of a durable pliable material, is shown in detail in FIG. 2, The free end of the straps 12B have multiple holes 16 for adjustments. The cinch 10 has permanently attached buckles 14 with locking tongues 18 on each opposing end of the cinch 10, as shown in detail in FIG. 3.

The method of securing the saddle 1 to a horse and manner of use of the improved cinch 10 of the present invention is shown in FIG. 1-4. The free end 12B of the strap 12 is inserted through the opening of the D-ring 4 and then down through the cinch buckle 14 as shown in FIG. 1. The free end 12B of the strap 12 will then be pulled upward to tighten the cinch 10 around the horse's belly. The single looping of the strap 12 through the D-ring 4 considerably reduces the amount of force needed by the horseman to pull the cinch 10 tight about the horse's belly and the leather to leather friction which occurs with more than one loop of the strap 12 is also reduced. Once the desired tightness of the cinch 10 around the horse's belly has been achieved, the tongue 18 of the cinch buckle 14 is extended through the appropriate hole 16 on the cinch strap 12. The downward tension of the strap 12 will securely keep the tongue 18 of the cinch buckle 14 in a locked position. The free end 12B of the strap 12 can also be tucked down into the cinch 10 as shown in FIG. 4. Both sides of the saddle 1 are secured by the cinch 10 in the same manner as described above.

The restrictive description and exemplary drawings of the specific examples above do not point out what an infringement of this patent would be. Various modifications can be made in the construction (only having one buckle instead of two), material, arrangement (only having one strap permanently attached as opposed to both straps permanently attached), and operation, and still be within the scope of our invention. The limits of the invention and the bounds of the patent protection are measured by and defined in the following claims.

We claim as our invention:

1. A cinch (girth) for equestrian saddles, comprising:
a belt having a first end and a second end,
at least one buckle attached to said first end and at least one buckle attached to said second end,
said belt having at least one strap which is permanently attached to said first end and at least one strap which is permanently attached to said second end,
said first end buckle and said second end buckle having a fastening tongue
movably attached to the buckle base for extending through a hole in the said first strap which is permanently attached to said first end and through a hole in the said second strap which is permanently attached to said second end,
said first strap which is permanently attached to said first end and said second strap which is permanently attached to said second end having multiple holes,
said belt having rings attached at a midsection of said belt.
